(19) United States
(12) Patent Application Publication
(10) Pub. No.: US 2012/0180753 A1
(43) Pub. Date: Jul. 19, 2012

(54) ACTIVE THERMAL SHIELD AND DIVERTER

(75) Inventors: Carl E. Fonville, Ann Arbor, MI (US); Roland C. Hawkins, Sterling Heights, MI (US)

(73) Assignee: GM GLOBAL TECHNOLOGY OPERATIONS LLC, Detroit, MI (US)

(21) Appl. No.: 13/005,772

(22) Filed: Jan. 13, 2011

(51) Int. Cl. F02B 77/11; B32B 3/10

(52) U.S. Cl. 123/198 E; 428/172

(57) ABSTRACT

A thermal shield-diverter includes a first layer and a second layer. Each of the first and second layers is formed from a material resistant to thermal energy, and each is characterized by a surface having a width and a height. The shield-diverter also includes a third layer formed from a material substantially non-conductive of thermal energy. The third layer is characterized by a third width and a third height, and is disposed between the first layer and the second layer to define at least one passage extending along at least one of the first height and the second height. The at least one passage is configured to divert thermal energy along the respective first and second heights and expel the thermal energy from the shield-diverter when the shield-diverter is exposed to a heat source. An engine assembly employing such a shield-diverter is also disclosed.

### TECHNICAL FIELD

The invention relates to an active thermal shield and diverter of thermal energy.

### BACKGROUND

Heat shields are typically designed to prevent a substance from absorbing excessive thermal energy or heat from an outside source by dissipating, reflecting, or absorbing such heat.

Motor vehicles often use heat shields to manage the thermal conditions because of large amounts of heat given off by internal combustion engines. On most engines, heat shields are used to protect various components and bodywork from heat damage. Additionally, heat shields can provide a performance benefit for the engine by reducing under-hood temperatures in critical locations in order to reduce temperature of the intake air. Automotive heat shields may be formed from a rigid sheet of steel or aluminum, or be formed from flexible aluminum sheeting that is bent manually by the fitter of the shield to conform to the target environment.

In situations where a thermally sensitive component is positioned in close proximity with an extreme heat source, managing thermal energy to prevent detrimental heat absorption by the subject component becomes even more challenging. In such situations, inability to effectively shield the sensitive component may lead to failure of the component and a malfunction of the system in which the component serves a key function. Design and selection of a heat shield for such an application may thus prove critical to the reliability of a subject system and to the satisfaction of the system's user.

### SUMMARY

A thermal shield-diverter includes a first layer and a second layer. Each of the first and second layers is formed from a material resistant to thermal energy, and each is characterized by a surface having a width and a height. The shield-diverter also includes a third layer formed from a material substantially non-conductive of thermal energy. The third layer is characterized by a third width and a third height, and is disposed between the first layer and the second layer to define at least one passage extending along at least one of the first height and the second height. The at least one passage is configured to divert thermal energy along the respective first and second heights and expel the thermal energy from the shield-diverter when the shield-diverter is exposed to a heat source.

The first width may be substantially equal to the second width and the first height may be substantially equal to the second height. Accordingly, the first and second layers may at least partially overlap the third layer along the first and second heights and may at least partially overlap the third layer along the first and second widths without restricting the passages in the first and second layers. Additionally, the first and second layers may be joined such that the third layer is retained by the first and second layers. The joining of the first and second layers may be accomplished by a crimping process.

The first layer may define a channel extending along the entire first height, and the second layer may define a channel extending along the entire second height. In such a case, the at least one passage may include a plurality of passages such that at least some of the plurality of passages are defined by the channel in the first layer and the channel in the second layer. Additionally, the third layer may define a channel extending along the entire third height such that the at least one passage is defined by the channel in the third layer.

Each of the first layer and the second layer may be formed from either steel or aluminum, while the third layer may be formed from ceramic.

The passage in the first layer may be formed substantially parallel to the passage in the second layer.

An internal combustion engine having an exhaust manifold employing the thermal shield-diverter to divert thermal energy given off by the exhaust manifold away from a sensitive component or area is also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of an internal combustion engine including a thermal shield-diverter covering an exhaust manifold;

FIG. 2 is an exploded perspective view of the shield-diverter shown in FIG. 1;

FIG. 3 is a perspective view of the shield-diverter shown in FIGS. 1 and 2, wherein the shield-diverter is depicted in an assembled state; and

FIG. 4 is an exploded perspective view of an alternative embodiment of the shield-diverter shown in FIGS. 1-3.

### DETAILED DESCRIPTION

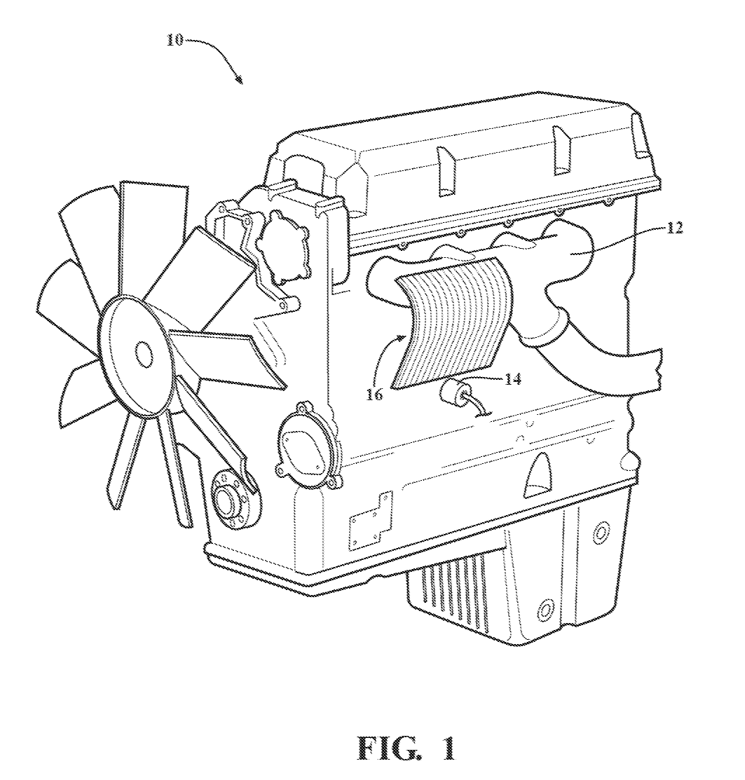

Referring to the drawings, wherein like reference numbers refer to like components, FIG. 1 shows a schematic perspective view of an internal combustion engine 10. The engine 10 may be a compression- or a spark-ignition type. The engine 10 includes an exhaust manifold 12. The exhaust manifold 12 is used to collect and channel exhaust gases expelled from the engine's cylinders (not shown) following combustion of the air-fuel mixture therein. The exhaust manifold 12 may be a standalone component or be integrated with a turbocharger (not shown), if such is used on the particular engine. As is known by those skilled in the art, post-combustion exhaust gases are often characterized by temperatures in excess of 1,000 degrees Celsius (C). In order to structurally withstand such temperatures, exhaust manifolds are typically cast from iron or fabricated from stainless steel.

As a result of being used to collect post-combustion exhaust gases, the exhaust manifold 12 absorbs significant thermal energy or heat from such gases, such that the surface temperature of the exhaust manifold may exceed 800 degrees C. Throughout operation of the engine 10, the exhaust manifold 12 radiates the absorbed thermal energy to the surrounding environment. The engine 10 also includes a component 14 located proximate to the exhaust manifold 12. The component 14 may include an intricate mechanism and/or various electrical connections, and be unable to withstand direct radiation of thermal energy from the exhaust manifold 12 without a malfunction or outright failure. For example, the component 14 may be a knock sensor such as often used in internal combustion engines for detection of irregular combustion inside the cylinders. As appreciated by those skilled in the art, such a knock sensor is typically incapable of withstanding direct radiation of thermal energy from a proximate heat source such as the exhaust manifold 12.

A thermal shield-diverter 16 is disposed between the exhaust manifold 12 and the component 14. The shield-diverter 16 may be mounted to the exhaust manifold 12, to the component 14, or to some other structure on the engine 10. When the shield-diverter 16 is mounted to the exhaust manifold 12, the shield-diverter 16 may be specifically shaped to cover the exhaust manifold 12 such that the body of the shield-diverter is in the direct path of the heat radiated by the exhaust manifold. The shield-diverter 16 may be mounted to the exhaust manifold 12 to the component 14, or to some other structure on the engine 10 by any appropriate means, such as with bolts or screws (not shown).

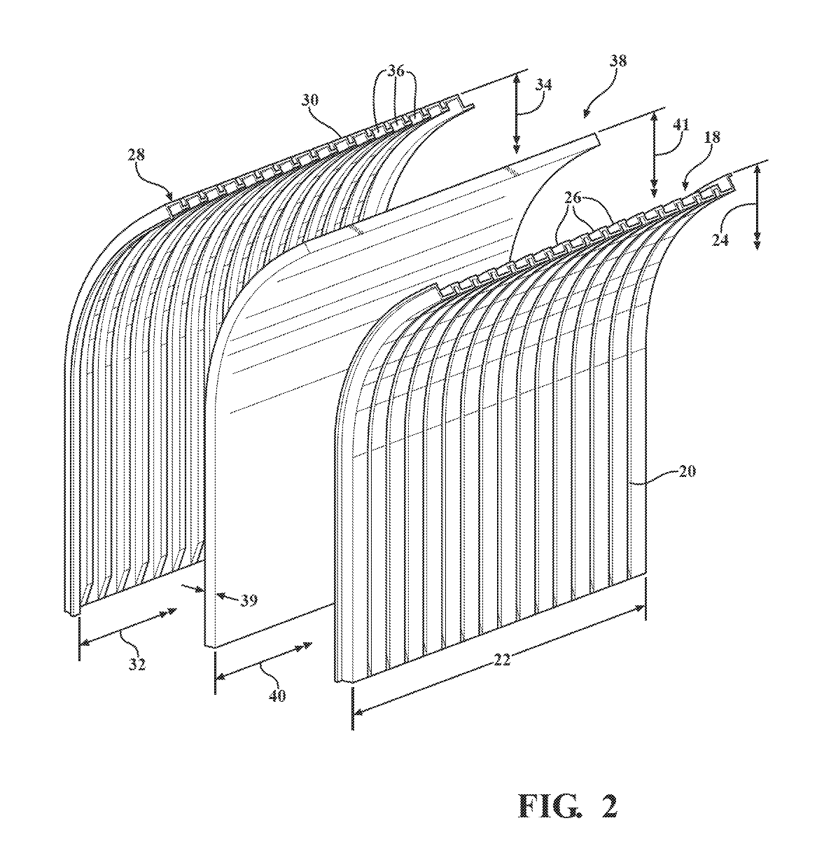

Referring to FIG. 2, the shield-diverter 16 includes a first layer 18 formed from a material resistant to thermal energy, i.e., the type that retains its solid structure when exposed to elevated temperatures, such as aluminum or steel. The first layer 18 is characterized by a first surface 20 having a first width 22, a first height 24, and a plurality of channels 26 extending along the entire first height. The shield-diverter 16 also includes a second layer 28 that is formed from a material resistant to thermal energy, similarly to the first layer 18. The second layer 28 is characterized by a second surface 30 having a second width 32, a second height 34, and a plurality of channels 36 extending along the entire second height. Each of the first and the second layers 18, 28 may be formed by a stamping process.

As shown in FIG. 2, the shield-diverter 16 additionally includes a third layer 38 formed from a material that is substantially non-conductive of thermal energy, such as ceramic. As is known by those skilled in the art, thermal conductivity k is the property of a material that indicates its ability to conduct heat. Thermal conductivity is measured in Watts per Kelvin per meter, i.e., k=W/(mK). The thermal conductivity predicts an amount of energy loss in watts through a unit area of the subject material having a specific thickness. A material is considered to be an effective insulator when its thermal conductivity is close to or less than approximately 1.0 W/(mK). For comparison, thermal conductivity of many ceramics is in the 0.1-1.0 W/(mK) range, thermal conductivity of stainless steel is around 15 W/(mK), while that of carbon steel is around 45 W/(mK), and thermal conductivity of aluminum is around 120-250 W/(mK). From the preceding examples it is evident that, in general, ceramics are substantially more effective thermal insulators than metals.

The third layer 38 is characterized by a thickness 39, a third width 40, and a third height 41. The third layer 38 is disposed between the first layer 18 and the second layer 28 such that the channels 26, 36 in the respective first layer and in the second layer form individual and distinct passages 42 and 44. The passages 42 and 44 are configured to divert thermal energy given off by the exhaust manifold 12 along the respective first and second heights 24, 34, and expel the thermal energy from the shield-diverter 16 by a phenomenon called stack effect, as described below. As shown, the passages 42 in the first layer 18 are substantially parallel to the passages 44 in the second layer 28. Furthermore, when the shield-diverter 16 is installed on the exhaust manifold 12, the passages 42, 44 are oriented substantially vertically with respect to the ground. Such orientation of the passages 42, 44 permits the most effective escape of the heated air from these passages.

Stack effect is the movement of air into and out of contained areas in structures such as buildings, chimneys, flue gas stacks, and other containers, and is driven by buoyancy. Such buoyancy generally occurs due to a difference in air density between the contained area and the ambient, typically resulting from differences in temperature and/or moisture. The result of such temperature and/or moisture differences is either a positive or a negative buoyancy force. Ultimately, the greater the thermal difference between the contained area and the ambient, as well as the height of the structure, the greater the buoyancy force, and, therefore, the greater the stack effect.

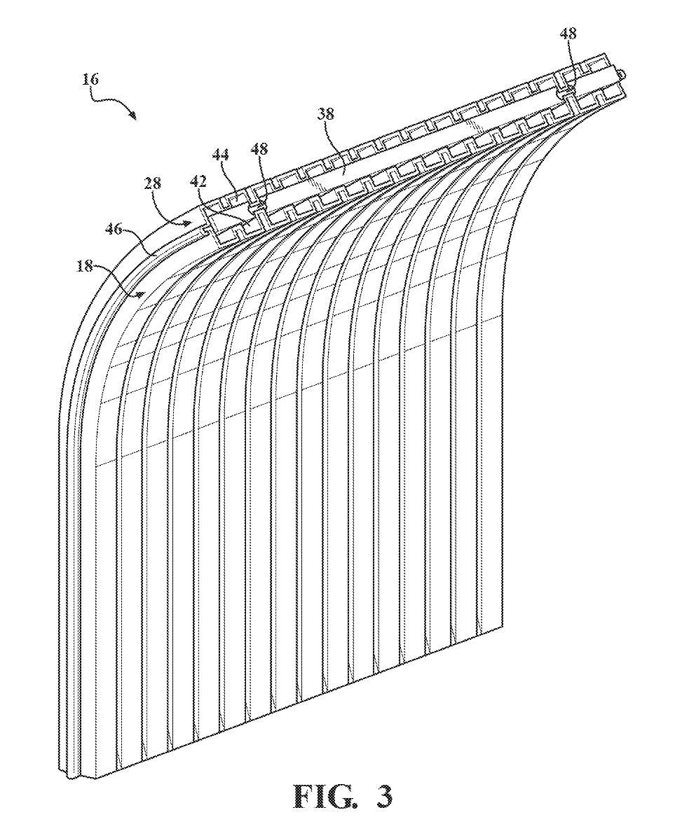

For the stack effect to be present there has to be a pressure difference “ΔP” between the contained area and the ambient caused by the difference in temperature between those two areas. Such pressure difference is the driving force for the stack effect, and it can be calculated with the equations presented below. The situation in the passages 42 and 44 of FIG. 3 is similar to that of a flue gas stack or a chimney characterized by a height “h”, and the equations below may provide an approximation of the flow induced by the stack effect.

$$Δ P = Cah ( \frac{1}{{T}_{o}} - \frac{1}{{T}_{i}} )$$

In the international system of units, a.k.a., SI, in the above equation “ΔP” is the available pressure difference in Pascals, “C” is a constant having a value of 0.0342, “a” is atmospheric pressure in Pascals, “h” is height or distance in meters, “Tₒ” is absolute outside temperature in Kelvin, and “Tᵢ” is absolute inside temperature in Kelvin. Furthermore, an approximation of the draft or draught flow rate induced by the stack effect can be calculated with the equation presented below. For flue gas stacks or chimneys, where air is on the outside and combustion flue gases are on the inside, the equation below provides an approximation of the draft or draught flow rate induced by the stack effect.

$$Q = CA \sqrt{2 gh \frac{{T}_{i} - {T}_{o}}{{T}_{i}}}$$

In the SI system of units, in the above equation “Q” is the stack effect draft/draught flow rate in m³/s, “A” is the cross-sectional flow area in m², “C” is the discharge coefficient (usually taken to be from 0.65 to 0.70), “g” is the gravitational acceleration (defined to be 9.81 m/s²), “h” is the height of the flue gas stack or chimney in meters (m), “Tᵢ” is the average inside temperature in Kelvin, and “Tₒ” is the outside air temperature in Kelvin.

By using the above described construction from relatively common materials, the shield-diverter 16 is capable of generating up to a 600 degree C. temperature drop across a distance of 20 mm. Such a significant temperature drop in a relatively short distance is otherwise difficult to achieve without using exotic and expensive materials to cover the exhaust manifold 12. This result is made possible because the shield-diverter 16 does not simply dissipate, reflect, or absorb the thermal energy given off by the exhaust manifold 12, but actually diverts and channels the heat away from the component 14. The overall effect of employing the shield-diverter 16 is to reduce the possibility that damage to the component 14 will occur even when such a component is positioned in close proximity to the exhaust manifold 12.

As may be seen from FIGS. 2 and 3, in the shield-diverter 16 the first width 22 is substantially equal to the second width 32, and the first height 24 is substantially equal to the second height 34. Additionally, the construction of the shield-diverter 16 is such that the first and the second layers 18, 28 overlap or cover the third layer 38 along the third height 41 and also partially overlap the third layer along the third width 40, without restricting airflow in the passages 42, 44. As shown in FIG. 3, the overlap of the third layer 38 along the third height 41 is accomplished via a crimp joint 46. The partial overlap of the third layer 38 along the third width 40 is accomplished via a local crimp joint 48 that does not restrict the passages 42, 44. The crimp joints 46, 48 ensure that the first and second layers 18, 28 are joined such that the third layer 38 is fixedly retained by the first and second layers. Although FIG. 3 depicts the shield-diverter 16 as having its structure maintained by the crimp joints 46, 48, other appropriate means for maintaining the structure, such as weld joints, etc., may also be used.

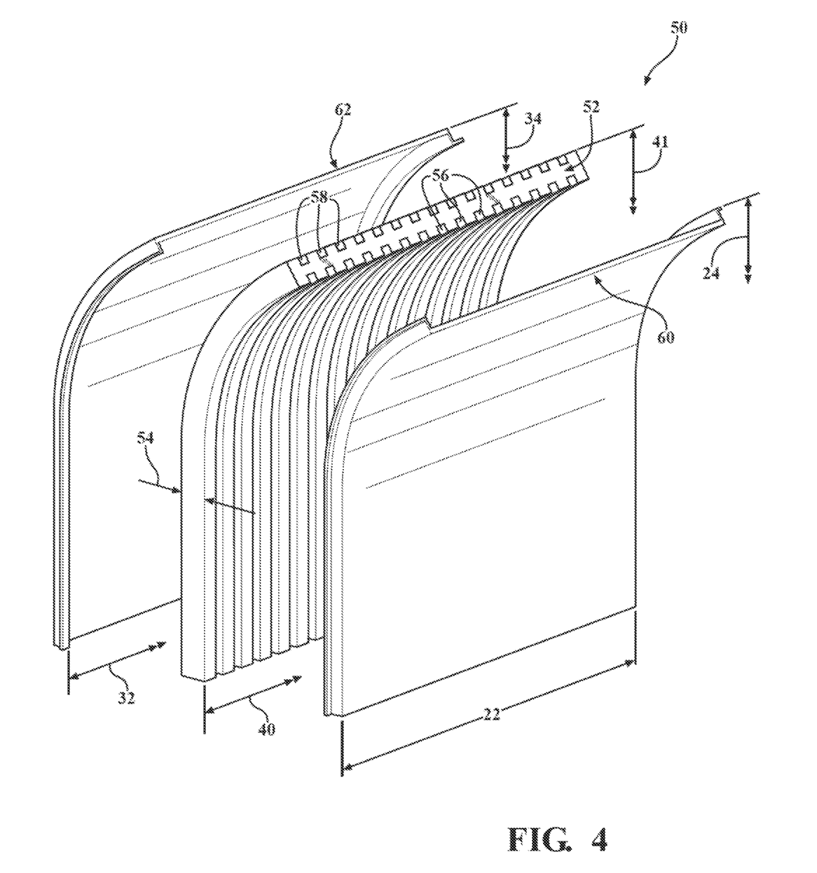

FIG. 4 shows an exploded perspective view of a shield-diverter 50, which is an alternative embodiment of the shield-diverter 16 shown in FIGS. 1-3. The alternative embodiment depicts a third layer 52 which is similar to the third layer 38 shown in FIGS. 1-3, except for having a thickness 54 which defines a plurality of channels 56 and 58 that extend along the entire third height 41. The alternative embodiment of FIG. 4 also depicts first and second layers 60, 62 which are similar to the first and second layers 18, 28, respectively, shown in FIGS. 1-3, except for being devoid of any channels.

In the alternative embodiment, when the third layer 52 is disposed between the first layer 60 and the second layer 62 the channels 56, 58 form individual and distinct passages on each side of the third layer along the height 41. Thus formed, the passages in the final assembly of the shield-diverter 50 become functionally identical to the passages 42, 44 of the shield-diverter 16. As such, similarly to the passages of the shield-diverter 16, the passages of the shield-diverter 50 are configured to divert thermal energy given off by the exhaust manifold 12 along the third height 41, and expel the thermal energy from the shield-diverter 50 by stack effect.

While the best modes for carrying out the invention have been described in detail, those familiar with the art to which this invention relates will recognize various alternative designs and embodiments for practicing the invention within the scope of the appended claims.

1. A thermal shield-diverter comprising:
a first layer formed from a material resistant to thermal energy;
a second layer formed from a material resistant to thermal energy; and
a third layer formed from a material substantially non-conductive of thermal energy;
wherein:
the first layer is characterized by a first surface having a first width and a first height;
the second layer is characterized by a second surface having a second width and a second height; and
the third layer is characterized by a third width and a third height and is disposed between the first layer and the second layer to define at least one passage extending along at least one of the first height and the second height such that the at least one passage is configured to divert thermal energy along the respective first and second heights and expel the thermal energy from the shield-diverter when the shield-diverter is exposed to a heat source.

2. The shield-diverter of claim 1, wherein the first width is substantially equal to the second width and the first height is substantially equal to the second height.

3. The shield-diverter of claim 2, wherein the first and second layers at least partially overlap the third layer along the third height and at least partially overlap the third layer along the third width without restricting the passages in the first and second layers.

4. The shield-diverter of claim 3, wherein the first and second layers are joined such that the third layer is retained by the first and second layers.

5. The shield-diverter of claim 4, wherein the first and second layers are joined by crimping.

6. The shield-diverter of claim 5, wherein:
the first layer defines a channel extending along the entire first height;
the second layer defines a channel extending along the entire second height; and
the at least one passage includes a plurality of passages such that at least some of the plurality of passages are defined by the channel in the first layer and the channel in the second layer.

7. The shield-diverter of claim 5, wherein the third layer defines a channel extending along the entire third height such that the at least one passage is defined by the channel in the third layer.

8. The shield-diverter of claim 1, wherein each of the first layer and the second layer is formed from one of steel and aluminum.

9. The shield-diverter of claim 1, wherein the third layer is formed from ceramic.

10. The shield-diverter of claim 1, wherein the passage in the first layer is substantially parallel to the passage in the second layer.

11. An internal combustion engine comprising:
an exhaust manifold configured to collect and expel post-combustion exhaust gases;
a component disposed relative to the exhaust manifold; and
a thermal shield-diverter disposed between the exhaust manifold and the component, the shield-diverter is configured to divert thermal energy given off by the exhaust manifold away from the component, the shield-diverter having:
a first layer formed from a material resistant to thermal energy;
a second layer formed from a material resistant to thermal energy; and
a third layer formed from a material substantially non-conductive of thermal energy;
wherein:
the first layer is characterized by a first surface having a first width and a first height;
the second layer is characterized by a second surface having a second width and a second height; and
the third layer is characterized by a third width and a third height and is disposed between the first layer and the second layer to define at least one passage extending along at least one of the first height and the second height such that the at least one passage is configured to divert the thermal energy along the respective first and second heights and expel the thermal energy from the shield-diverter.

12. The engine of claim 11, wherein the shield-diverter is mounted to the exhaust manifold.

13. The engine of claim 11, wherein the first width is substantially equal to the second width and the first height is substantially equal to the second height.

14. The engine of claim 13, wherein the first and second layers at least partially overlap the third layer along the third height and at least partially overlap the third layer along the third width without restricting the passages in the first and second layers.

15. The engine of claim 14, wherein the third layer defines a channel extending along the entire third height such that the at least one passage is defined by the channel in the third layer.

16. The engine of claim 14, wherein the first and second layers are joined such that the third layer is retained by the first and second layers.

17. The engine of claim 16, wherein:
the first layer defines a channel extending along the entire first height;
the second layer defines a channel extending along the entire second height; and
the at least one passage includes a plurality of passages such that at least some of the plurality of passages are defined by the channel in the first layer and the channel in the second layer.

18. The engine of claim 11, wherein each of the first layer and the second layer is formed from one of steel and aluminum.

19. The engine of claim 11, wherein the third layer is formed from ceramic.

20. The engine of claim 11, wherein the passage in the first layer is substantially parallel to the passage in the second layer.
